(19) United States
(12) Patent Application Publication
(10) Pub. No.: US 2013/0238582 A1
(43) Pub. Date: Sep. 12, 2013

(54) METHOD FOR OPERATING FILE SYSTEM AND COMMUNICATION DEVICE

(71) Applicant: HUAWEI TECHNOLOGIES CO., LTD., Shenzhen (CN)

(72) Inventors: Guangzhi LI, Shenzhen (CN); Haichun FU, Shenzhen (CN)

(73) Assignee: Huawei Technologies Co., Ltd., Shenzhen (CN)

(21) Appl. No.: 13/870,621

(22) Filed: Apr. 25, 2013

Related U.S. Application Data
(63) Continuation of application No. PCT/CN2011/074680, filed on May 26, 2011.

(30) Foreign Application Priority Data
Nov. 1, 2010 (CN) 201010532514.3

(51) Int. Cl. G06F 17/30

(52) U.S. Cl. CPC G06F 17/30091
USPC 707/705

(57) ABSTRACT

A method for operating a file system and a communication device are disclosed. The method comprises: receiving a file operation request from a user, and according to the file operation request, transmitting a file operation instruction to a hardware acceleration unit, such that the hardware acceleration unit operates a data file in a storage device in accordance with the file operation instruction and returns the operated data to a user directly without via a central processing unit (CPU) so as to realize the communication between the user and the data file in the storage device. The operation on the data file is completed by the hardware acceleration unit and the operated data is returned to the user directly without via CPU. The performance of the hardware acceleration unit can be sufficiently used and the data transmission with high bandwidth can be realized.

### CROSS-REFERENCE TO RELATED APPLICATIONS

This application is a continuation of International Patent Application No. PCT/CN2011/074680, filed on May 26, 2011, which claims priority to Chinese Patent Application No. 201010532514.3, filed on Nov. 1, 2010, both of which are hereby incorporated by reference in their entireties.

### TECHNICAL FIELD

The present invention relates to the field of communication technology, and more particularly, relates to a method for operating a file system and a communication device.

### BACKGROUND

A file system is a software mechanism which is responsible for managing and storing data file information in an operating system. The file system consists of three parts: software related to data file management, managed data file, and data structure required for implementing data file management. From a system perspective, the file system is a system which organizes and allocates file storage space, and is responsible for storing a data file and protecting and retrieving the stored data file.

Currently, the operation of a file system is mainly completed by an operating system kernel, in which, the file system obtains configuration information of a data file according to a file name, initiates an operation to a storage device according to the configuration information, reads corresponding storage data and places the storage data within a data buffer of the operating system kernel, then copies the same to a user memory for being correspondingly processed by a CPU.

During the implementation of the present invention, the inventor has found at least the following problems in the prior art:

According to the operation manner of a conventional file system, operations on all stored data need to be completed through a CPU. When file data with high-bandwidth (such as a streaming media file in the field of telecommunications) is processed, although storage bandwidth requirement can be satisfied by using a SSD (Solid State Disk) technology, the existing CPU processing capability cannot satisfy the high bandwidth processing requirement. Thus, it is desirable to provide a new technology to achieve the processing of file data with high-bandwidth.

### SUMMARY

In order to make the file system satisfy the requirement of processing stored data by a CPU plus an external hardware acceleration unit, the embodiment of the present invention provides a method for operating a file system and a communication device. The technical solutions are as follows.

A method for operating a file system comprises: receiving a file operation request from a user; according to the file operation request, transmitting a file operation instruction to a hardware acceleration unit such that the hardware acceleration unit operates a data file in a storage device in accordance with the file operation instruction and returns the operated data to the user directly without via a central processing unit (CPU), so as to realize the communication between the user and the data file in the storage device.

The embodiments of the present invention also provide a communication device which comprises: a central processing unit (CPU), a storage device and a hardware acceleration unit; wherein, the CPU for receiving a file operation request from a user and according to the file operation request, transmitting a file operation instruction to the hardware acceleration unit; the hardware acceleration unit operates a data file in the storage device in accordance with the file operation instruction, so as to realize the communication between the user and the data file in the storage device.

The technical solutions provided by the embodiments of the present invention can bring the following beneficial effects.

According to the embodiments of the present invention, the operation on a data file is completed and the operated data is returned to a user directly by a hardware acceleration unit without via a central processing unit (CPU). As the processing performance of the hardware acceleration unit is much better than that of the CPU, the performance of the hardware acceleration unit can be sufficiently used and the data transmission with high bandwidth can be realized.

### BRIEF DESCRIPTION OF THE DRAWINGS

FIG. 1 is a flowchart diagram of a method for operating a file system provided by Embodiment One of the present invention;

FIG. 2 is a flowchart diagram of a method for operating a file system provided by Embodiment Two of the present invention;

FIG. 3 is a structural diagram of a communication device provided by Embodiment Three of the present invention; and

FIG. 4 is a structural diagram of a communication device provided by Embodiment Three of the present invention.

### DESCRIPTION OF EMBODIMENTS

To make the objects, the technical solutions and the advantages of the present invention much clearer, the embodiments of the present invention will be described in detail in conjunction with the accompanying drawings.

### Embodiment One

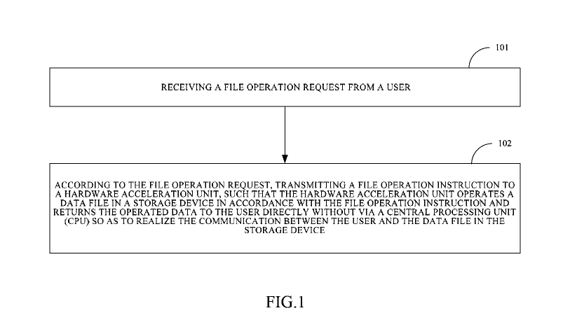

With reference to FIG. 1, this embodiment provides a method for operating a file system. The method comprises:

101: receiving a file operation request from a user.

The user can perform relevant operations on a data file in a storage device by transmitting the file operation request, wherein, the file operation request can be requests such as reading a file and uploading a file.

102: according to the file operation request, transmitting a file operation instruction to a hardware acceleration unit such that the hardware acceleration unit operates a data file in a storage device in accordance with the file operation instruction, and returns the operated data to the user directly without via a central processing unit (CPU), so as to realize the communication between the user and the data file in the storage device.

After step 101, the embodiment of the present invention can further comprise: determining an accessed object in accordance with the file operation request, if the accessed object is a streaming media file, entering a separate operation mode, wherein according to the file operation request, transmitting a file operation instruction to the hardware acceleration unit such that the hardware acceleration unit operates a data file in a storage device in accordance with the file operation instruction.

Otherwise, if the accessed object is not a streaming media file, entering an ordinary operation mode, wherein according to the file operation request, transmitting a file operation instruction to an operating system kernel such that the operating system kernel operates a data file in a storage device in accordance with the file operation instruction.

In the embodiment of the present invention, the storage device can be a memory with a high bandwidth such as a solid state disk (SSD), and the hardware acceleration unit can be a programmable logic device (PLD) or an application-specific integrated circuit (ASIC). If a PLD is used for implementing the hardware acceleration unit, in particular, a field programmable logic device (FPGA) can be used.

In the embodiment of the present invention, the operation on a date file is completed and the operated data is returned to a user directly by a hardware acceleration unit without via a central processing unit (CPU). As the processing performance of the hardware acceleration unit is much better than that of the CPU, the performance of the hardware acceleration unit can be sufficiently used and the data transmission with high bandwidth can be realized.

Meanwhile, the embodiment of the present invention also provides two kinds of operation modes. The above-mentioned separate operation mode in which the processing is performed directly by the hardware acceleration unit without via a CPU is mainly suitable for a streaming media file (with a large bandwidth consumption amount). Meanwhile, for an ordinary file operation, the embodiment of the present invention also provides an ordinary operation mode, in which a non-streaming media file is operated based on an existing file system implementation method. Thus, the original file system operation interface is maintained while realizing a high bandwidth data processing, and data processing of a non-hardware acceleration operation can be compatible and the compatibility of the system is enhanced.

### Embodiment Two

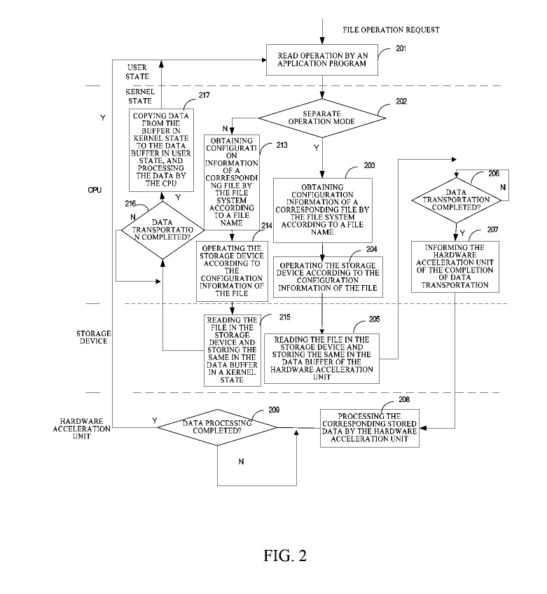

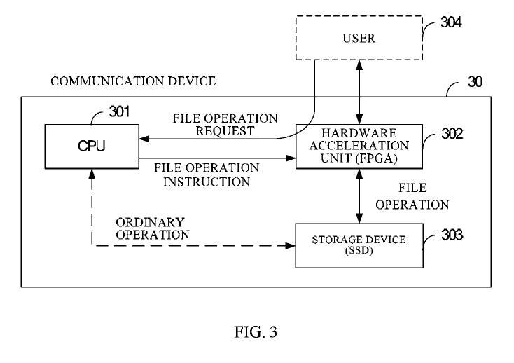

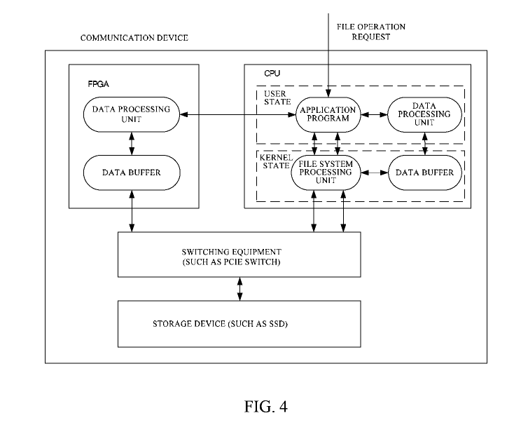

With reference to FIG. 2, this embodiment is based on Embodiment One and provides a particular operating method of a file system. This method can be implemented on the basis of the hardware architectures provided by FIGS. 3 and 4. This method comprises the following steps:

201: performing a read operation by an application program;

Herein, the application program refers to an application program in a CPU for processing an access instruction from a user. After receiving a user request, the application program processes the user request. If it is required to perform a read operation on a file, a corresponding read operation is started. In the embodiment of the present invention, the user request can be firstly sent to the hardware acceleration unit, and then the hardware acceleration unit forwards the access request to the CPU through a corresponding communication interface.

The CPU is under a user state, and the interaction between the application program and the file system is performed based on a file name. The file system can obtain the corresponding configuration information (Layout information) of the data file according to the file name. The configuration information gives information such as a storage address (e.g., logic block address) and a data length of the data file. With the configuration information, the content of the data file can be obtained from the storage device (e.g., SSD) that stores the data file.

202: determining whether it is a separate operation mode;

After receiving the file operation request (e.g. read operation) from the user, the CPU judges whether it is a separate operation mode in accordance with the file operation request, that is, whether to transmit a file operation instruction to the hardware acceleration unit. The basis for the judgment is the type of the data file to be operated. If it is a streaming media file (e.g., files such as MP4, flv), entering the separate operation mode and subsequently performing step 203 to transmit the file operation instruction to the hardware acceleration unit; otherwise, if it is not operating a streaming media file (e.g. accessing a txt document in the local U-disk), entering the normal operation mode and subsequently performing step 213 to transmit the file operation instruction to an operating system kernel of the CPU.

The normal operation mode employs the operation manner of the current file system, that is, the main operations on the data file are completed by the operating system kernel of the CPU. Under a user state, the file system obtains configuration information of the data file according to the file name, and then initiates an operation to the storage device in accordance with the configuration information, reads the corresponding storage data in the storage device and places the corresponding storage data in a data buffer of the operating system kernel. At this point, in the CPU, by means of memory copy, the storage data within the data buffer of the operating system kernel is copied to the user memory and processed by the CPU. After the CPU has finished processing the corresponding storage data, the file system reports to the user application program the information that the CPU has finished the processing.

203: when the operation type is the separate operation mode, the file system obtains configuration information of a corresponding file according to a file name;

The interaction between the application program and the file system are performed based on the file name. The file system can obtain corresponding configuration information of the data file according to the file name. With the configuration information, contents of the data file can be obtained.

204: operating the storage device according to the configuration information of the file;

With the configuration information, contents of the data file can be obtained. The configuration information of the file is a file information table which can be placed at the file header and contains the length of the file and the logic address where the file is stored. In such way, with the configuration information, the logic address where the file is stored can be obtained. With the logic address, the storage device can be operated, thereby obtaining relevant contents of the file that is stored in the storage device.

205: reading the file data in the storage device and storing the same in the data buffer of the hardware acceleration unit;

With the configuration information of the file, the logic address where the file is stored can be obtained. File data stored at the logic address is read from the storage device and the read file data is stored in the data buffer of the hardware acceleration unit.

206: judging whether the file data in the storage device are all stored in the data buffer of the hardware acceleration unit;

By moving (transporting) data in the storage device into the data buffer of the hardware acceleration unit, it is judged whether all the data have been transported during the transportation of data, and until all the data have been transported, step 207 is executed.

207: informing the hardware acceleration unit of the completion of data transportation;

After all the file data have been transported, the hardware acceleration unit is informed that data transportation is completed. After receiving the information that all the data has been transported, the hardware acceleration unit executes step 208.

208: the hardware acceleration unit processes the corresponding stored data;

The hardware acceleration unit processes the stored data read from the storage device. At step 209, it is judged whether the hardware acceleration unit has already finished processing the stored data. When the hardware acceleration unit has already finished processing the stored data, it informs the application program. During this process, CPU does not need to process the data and data processing is completed by the hardware acceleration unit, that is, the hardware acceleration unit transmit the data directly to the user without via the CPU. Since the hardware acceleration unit is implemented based on a hardware (FPGA, ASIC), its processing performance (high bandwidth) is much better than that of the CPU, and thus data transmission with high bandwidth can be realized.

209: judging whether the hardware acceleration unit has finished processing the stored data;

After the hardware acceleration unit has already finished processing the stored data, it informs the application program.

Through steps 203 to 209, the CPU sends a file operation instruction to the hardware acceleration unit according to the file operation request such that the hardware acceleration unit operates the data file in the storage device in accordance with the file operation instruction, so as to realize the communication between the user and the data file in the storage device.

On the other hand, when the CPU judges that the operation on the file operation request is a normal operation mode in accordance with the file operation request, step 213 is performed:

213: when the operation type is not a separate operation mode (i.e. a normal operation mode), the file system obtains configuration information of the corresponding file according to the file name; the interaction between the application program and the file system is performed based on the file name. The file system can obtain the corresponding configuration information of the data file according to the file name. With the configuration information, the CPU can obtain the content of the data file.

214: operating the storage device according to the configuration information of the file;

With the configuration information, contents of the data file can be obtained. The configuration information of the file is a file information table which can be placed at the file header and contains the length of the file and the logic address where the file is stored. In such way, with the configuration information, the logic address where the file is stored can be obtained by the CPU through the file system. With the logic address, the storage device can be operated, thereby obtaining relevant contents of the file stored in the storage device.

215: reading the file data in the storage device and storing the same in the data buffer of the operating system kernel;

With the configuration information of the file, the logic address where the file is stored can be obtained. File data stored at the logic address can be read and the read file data is stored in the data buffer of the operating system kernel (kernel state).

216: judging whether the file data in the storage device are all stored in the data buffer of the operating system kernel (kernel state);

By moving (transporting) data in the storage device into the data buffer of the operating system kernel (in kernel state), it is judged whether all the data have been transported during the transportation of data, and until all the file data have been transported, step 217 is executed.

217: copying data from the buffer in kernel state to the data buffer in user state;

After all the file data have been transported, data is copied from the buffer in kernel state to the data buffer in user state and processed by the CPU. When the CPU has finished processing the data, it informs the application program.

This embodiment divides the operations on a data file into a normal operation mode and a separate operation mode, so as to separate the signalling control of the file system from the data delivery, to complete data delivery of the stored data in a different manner, which addresses the problem that the stored data must be delivered via the CPU and meanwhile maintains the original file system operation interface and ensures the compatibility with non-hardware acceleration data processing. Thus, the data controlling and data processing capabilities of the system are enhanced.

### Embodiment Three

This embodiment provides a communication device 30. With reference to FIG. 3, the device comprises: a central processing unit CPU301, a hardware acceleration unit 302, and a storage device 303.

The CPU301 is used for receiving a file operation request from a user 304; and according to the file operation request, transmitting a file operation instruction to the hardware acceleration unit 302 such that the hardware acceleration unit 302 operates a data file in the storage device 303 in accordance with the file operation instruction, so as to realize the communication between the application program (user) 304 and the data file in the storage device 303.

In the embodiments of the present invention, the user is not directly connected to the CPU301 in terms of the hardware, but connected to the hardware acceleration unit 302. The instruction is transmitted to the CPU by the hardware acceleration unit through a corresponding interface (not shown) between the CPU and the hardware acceleration unit. In such way, the hardware externally (with respect to the user) only needs one interface, which is convenient for management.

Wherein, the hardware acceleration unit 302 can be a programmable logic device (PLD), such as field programmable gate array (FPGA), complicated programmable logic device (CPLD); or the hardware acceleration unit can be implemented through an ASIC (Application-Specific Integrated Circuit) chip.

Wherein, the CPU301 also can be used for determining an accessed object according to the file operation request. If it is a streaming media file, entering the separate operation mode, and according to the file operation request, transmitting the file operation instruction to the hardware acceleration unit such that the hardware acceleration unit operates the data file in the storage device in accordance with the file operation instruction.

With reference to FIG. 4, FIG. 4 is a diagram for describing the embodiment of FIG. 3 in detail. The CPU can be divided into a user state and a kernel state, wherein, the user state includes an application program for processing a user access request and a data processing unit for processing data, the kernel state includes a file system processing unit for performing a file system processing based on the prior art and a data buffer for performing data buffering.

The hardware acceleration unit is implemented using a FPGA in this embodiment, which comprises a data processing unit and a data buffer, wherein, the data processing unit is used for performing data processing while the data buffer is used for performing data buffering.

The data buffers of the above-mentioned CPU and FPGA can be implemented using externally joined SDRAMs. The implementation technology of this buffer is already known to one of ordinary skill in the art, and thus details thereof are omitted.

Meanwhile, switching equipment can be provided between the CPU, the hardware acceleration unit and the storage device, such as, PCIE Switch to realize high-speed data transmission.

The communication device provided by this embodiment and the method embodiments belong to the same concept. As for the implementations of the respective units, reference can be made to the method embodiments, and details thereof are omitted.

This embodiment divides the operations on a data file into a normal operation mode and a separate operation mode, so as to separate the signalling control of the file system from the data delivery, to complete data delivery of the stored data in a different manner, which addresses the problem that the stored data must be delivered via the CPU and meanwhile maintains the original file system operation interface and ensures the compatibility with non-hardware acceleration data processing. Thus, the data controlling and data processing capabilities of the system are enhanced.

All or part of the contents in the technical solutions provided by the above embodiments can be realized by software programming, wherein, software programs can be stored in a readable storage medium, and the readable storage medium can be a hard disk, an optical disk or a floppy disk in a computer.

The above are merely preferred embodiments of the present invention, but not limitations on the present invention. All modifications, equivalent replacements, and improvements made within the spirit and the principle of the present invention should be contained in the claimed scope of the present invention.

What is claimed is:

1. A method for operating a file system, comprising:
receiving a file operation request from a user;
transmitting, according to the file operation request, a file operation instruction to a hardware acceleration unit;
operating, by the hardware acceleration unit, on data in a data file in a storage device in accordance with the file operation instruction; and
returning the operated data to the user directly via a central processing unit (CPU), so as to realize communication between the user and the data file in the storage device.

2. The method of claim 1, wherein after receiving the file operation request from the user, the method further comprises:
determining an accessed object in accordance with the file operation request, and if the accessed object is a streaming media file, then:
entering a separate operation mode, and
transmitting the file operation instruction to the hardware acceleration unit in the separate operation mode, according to the file operation request, so that the hardware acceleration unit operates the data file in the storage device in accordance with the file operation instruction.

3. The method of claim 2, further comprising,
if the accessed object determined in accordance with the file operation request is not the streaming media file, entering an ordinary operation mode;
transmitting the file operation instruction to an operating system kernel in the ordinary operation mode, according to the file operation request, so that the operating system kernel operates the data file in the storage device in accordance with the file operation instruction.

4. The method of claim 1, wherein the storage device is a solid state disk (SSD), and the hardware acceleration unit is one of the group consisting of a programmable logic device (PLD) and an application-specific integrated circuit (ASIC).

5. A communication device, comprising:
a central processing unit (CPU), a storage device and a hardware acceleration unit; wherein,
the CPU is configured to receive a file operation request from a user, and according to the file operation request, transmit a file operation instruction to the hardware acceleration unit; and
the hardware acceleration unit is configured to operate a data file in the storage device in accordance with the file operation instruction, so as to realize communication between the user and the data file in the storage device.

6. The communication device of claim 5, wherein the CPU is further configured to:
determine an accessed object in accordance with the file operation request, and if the accessed object is a streaming media file, then:
entering a separate operation mode, and
transmitting the file operation instruction to the hardware acceleration unit in the separate operation mode, according to the file operation request, so that the hardware acceleration unit operates the data file in the storage device in accordance with the file operation instruction.

7. The communication device of claim 5, wherein,
the storage device is a solid state disk (SSD), and the hardware acceleration unit is one of the group consisting of a programmable logic device (PLD) and an application-specific integrated circuit (ASIC).
